(19) United States
(12) Patent Application Publication
(10) Pub. No.: US 2019/0352541 A1
(43) Pub. Date: Nov. 21, 2019

(54) ADHESIVE WRAPPING TAPE

(71) Applicant: CERTOPLAST TECHNISCHE KLEBEBÄNDER GMBH, Wuppertal (DE)

(72) Inventor: Timo LEERMANN, Wuppertal (DE)

(21) Appl. No.: 16/473,849

(22) PCT Filed: Dec. 11, 2017
(86) PCT No.: PCT/EP2017/082224

§ 371 Date: Jun. 26, 2019

(30) Foreign Application Priority Data
Jan. 3, 2017 (DE) 20 2017 100 009.5

(51) Int. Cl. C09J 7/30; C09J 5/00

(52) U.S. Cl. CPC C09J 7/30; C09J 5/00; C09J 2203/302; C08K 7/28; C09J 2205/11; C09J 2433/00; C09J 2421/00; C09J 2205/102

(57) ABSTRACT

The invention relates to an adhesive tape, particularly wrapping tape for surrounding cables in automobiles, comprising an elongate support, and an adhesive coating applied to one side or both sides. Hollow bodies which mainly have a stable structure with a grammage of up to 10 wt. %, in particular up to 5 wt. %, with respect to the adhesive mass, are embedded in the adhesive.

The invention relates to an adhesive tape, particularly wrapping tape, for sheathing cables in automobiles, with an elongated substrate and an adhesive-based coating on one or both faces.

Adhesive tapes and, in particular, wrapping tapes for sheathing cables in automobiles must meet a variety of requirements. These include not only easy unwindability, because the adhesive tapes or wrapping tapes in question are typically wrapped by hand around the cables to be sheathed. Also, the wrapping tape must be able to withstand elevated temperatures of up to 150° C. or even more. In addition, it is important that the insulation of the cable to be sheathed not become brittle due to the influence of the adhesive tape over an extended period. Finally, the adhesive tapes or wrapping tapes in question must also have good compatibility with chemicals, particularly with gasoline, oil, or comparable media in for example the engine compartment.

Moreover, it is also important for the noise to be suppressed. In fact, the cables that are sheathed in the wrapping tape should be acoustically damped within the automobile in terms of any rattling or impact noises during operation. A multiplicity of different approaches exist in the prior art for this purpose, all of which aim to achieve the desired noise reduction by modifying the substrate. For instance, it is known from the generic prior art according to EP 2 034 576 to work with a first and a second substrate. The first substrate can be an aluminum composite material, and the second substrate is made of a fabric, particularly a PET fabric.

Moreover, other combinations of materials are conceivable in which the first substrate is made of a plastic film and the second substrate is made of a fabric. It is also conceivable for the first substrate to be made of a fabric and the second substrate to be made of a nonwoven. The aim here is for the desired abrasion resistance to be achieved on the one hand and for high noise reduction to be achieved on the other hand, among other things. The effort and expense involved in manufacturing is great, however, because the individual substrates have to be produced separately and combined.

Another design variant is described in utility model DE 20 2012 104 161 [US 2015/0299522]. There, a substrate made of a knitted fabric made of yarn stitches is used. In addition, the substrate has weft yarns that extend parallel to one another in the transverse direction and are held in the stitches of the knitted fabric. In that case as well, the manufacturing effort and expense for the substrate is considerable.

It is true that the known embodiments have categorically proven their worth when it comes to reconciling the above-described requirements and particularly the conflicting objectives of high abrasion protection on the one hand and good noise reduction on the other hand. However, fulfilling these contradictory objectives comes with a steep price: the manufacturing effort and expense required to make the substrate is high and, consequently, the adhesive tapes can only be offered at an elevated price compared to products that have hitherto been available on the market. What is more, due to the special measures taken during manufacture of the substrate, the weight of the adhesive tape produced in this way can or does increase, so that overall handling becomes difficult. Another contributing factor in this respect is that the previously described and known adhesive tapes are (now) practically impossible to tear by hand due to their special support structure.

However, the so-called manual tearability or cross-tearability in the transverse direction of the longitudinally extended substrate and consequently also of the adhesive tape is an essential requirement of cable-set manufacturers in order to keep the processing as simple as possible and to eliminate the need for an additional cutting operation when the individual strips of adhesive tape are cut to length. According to the prior art according to DE 600 31 332 [U.S. Pat. No. 6,790,505], a so-called transverse tearing force of no more than 10 N is regarded as the criterion for manual tearability. That is, as long as the tearing strength in the transverse direction of the adhesive tape is less than 10 N, the adhesive tape is deemed overall to be manually tearable.

Noise reduction and a number of other criteria in the assessment of wrapping tapes for sheathing cables in automobiles are summarized in test guideline LV 312 “Protection systems for wiring harnesses in motor vehicles” (for example edition 2009). The test guideline is based on a common set of rules of the companies Audi, BMW, Daimler, Porsche, and VW and contains test specifications as well as criteria and quantitative data for quantities that are important in terms of performance. These include temperature classes, noise-reduction behavior, and abrasion resistance, among other things.

LV 312 distinguishes between a total of five different noise reduction classes, A to E, which are described in detail in the above-mentioned prior art of EP 2 034 576. Reference is made, inter alia, to paragraph [0034] of that document. Noise reduction class A corresponds to “no noise reduction,” whereas noise reduction class E reflects “very high noise reduction.” Class C, which is the class that is of interest in this context, corresponds to “medium noise reduction,” and class D represents “high noise reduction.”

The individual noise reduction classes reflect the behavior of the adhesive tape or cable set wrapped in this way and the effect of the adhesive tape on the noise generation, which is measured in each case as noise reduction in dB(A). As described in detail in EP 2 034 576, the individual noise-reduction classes now correspond to the different levels of noise reduction that are achieved with them, with class C representing a range of greater than 5 to 10 dB(A) and noise reduction class D representing the range of greater than 10 to 15 dB(A), for example.

The object of the invention is to further develop such an adhesive tape in such a way that, overall, a high level of noise reduction is achieved, particularly in consideration of a design that is structurally simpler than those of the prior art.

In order to attain this object, an adhesive tape according to the invention of this generic type and, in particular, wrapping tape for sheathing cables in automobiles, is characterized in that largely structurally stable hollow bodies with a grammage of up to about 10% by mass and particularly up to about 5% by mass based on the mass of the adhesive are embedded in the adhesive.

In the context of the invention, the structural stability of the hollow body means that during processing the hollow bodies in question undergo a change in volume in the range of up to about ±20%, particularly no more than ±10%, relative to their original volume. The invention proceeds here from the realization that the hollow bodies in question are typically added to an adhesive composition and applied to the substrate together with the adhesive composition. This can be done in such a way that the adhesive composition is heated, for example during metering and also during application to the substrate, as is known with acrylate- or rubber-based “hot melt adhesives” that are processed in this way, generally through nozzle application or rolling, to be specific.

Processing temperatures of well above 100° C. or even 150° C. and more are observed during such processes. In this context, the largely structurally stable design of the hollow bodies means that changes in their volume that inevitably occur due to the elevated temperature remain within the described range and do not exceed ±20% relative to the original volume as a maximum. Preferably, changes in volume of only ±10% as a maximum are even observed.

In addition to such roller or nozzle application in a hot and flowable state, it is of course also conceivable to apply the adhesive with the structurally stable hollow bodies introduced therein to the substrate as a dispersion. In this case, the largely structurally stable design of the hollow bodies enures that the hollow bodies also undergo practically no change in volume or only within the prescribed range up to a maximum of ±20%, which is possible in principle through contact with an inevitable solvent in such dispersions. In any case, the hollow bodies are thus designed to be largely structurally stable and typically uniformly distributed in the adhesive. This already occurs by virtue of the described method of applying the adhesive.

Moreover, the largely structurally stable design of the hollow bodies ensures that they are still closed cells, particularly even in the finished adhesive tape. The hollow bodies cannot “burst” or otherwise be destroyed during processing of the adhesive, for example. The closed-cell nature of the hollow bodies ensured in this manner, in conjunction with their grammage of up to 10% by mass relative to the adhesive composition, has the overall effect of ensuring that particular advantages and properties are observed for the adhesive tape of the invention configured in this way.

These advantages include not only a reduced use of adhesive compared to a variant that dispenses with the hollow bodies in question. In fact, the amount of adhesive used can be reduced by up to about 10% by mass through the partial substitution thereof by the hollow bodies, thus reducing the consumption of adhesive in like proportion. At the same time, this also has a positive influence on the total weight of an adhesive tape configured in this way. After all, the hollow bodies have a specific density of less than 0.8 g/cm³ over a much lower density than acrylate adhesive, for example, which has a density of about 1 g/cm³. Another special advantage that must also be considered is that the hollow bodies introduced into the adhesive correspond to a significant noise reduction compared to a coating having adhesive without hollow bodies.

In fact, according to the invention, the noise reduction is at least about 10% greater compared to an adhesive tape of the same construction without adhesive bodies introduced into the adhesive. For example, the noise-reduction class can be increased through the inclusion of the hollow bodies in the adhesive in an adhesive tape having the same structure otherwise, for example from noise reduction class C without hollow bodies to noise reduction class D with embedded hollow bodies, each measured in accordance with the abovementioned LV 312 standard.

All of this is possible in the described comparison without altering the substrate in any way or the need to select a special substrate construction. On the contrary, it has proven advantageous if a conventional and single-layer substrate is used that typically has a thickness of less than 1 mm, particularly 0.9 mm and less. Preferably, the thickness of the substrate can even be set to 0.5 mm and less.

As a matter of principle, a very wide variety of materials and embodiments have proven to be advantageous for the invention. For instance, the substrate can be a film, a woven fabric, particularly a PET fabric, a nonwoven fabric, a knitted fabric, a stitch-bonded nonwoven, a stitch-bonded fabric, a warp-knitted fabric, etc., individually or in combination. That is, the substrate can in principle be made of two or more layers. As a rule, however, such a multilayer or multi-ply structure is not required because, according to the invention, it is primarily the coating with the adhesive that provides for the desired noise reduction by means of the embedded, structurally stable hollow bodies instead of the substrate or in addition thereto.

The substrate, on the other hand, can be designed largely with the aim of providing the highest possible abrasion protection. This is achieved particularly in the event that a woven fabric is used here. For example, the fabric may be a polyester or polyamide fabric having an especially high abrasion resistance. The grammage of the substrate embodied in this way may be in the range from 100 g/m² to 200 g/m² in this connection. In fact, abrasion resistance commensurate with abrasion protection class D or even abrasion protection class E according to the LV 312 standard are observed in this context.

All of this is advantageously achieved while maintaining or reaching the required manual tearability. That is, according to a preferred embodiment, the adhesive tape of the invention is designed such that it can be torn by hand. For the purposes of the invention, this expression refers to a tearing force in the transverse direction of the adhesive tape of no more than 10 N as described in detail in the prior art in above-cited DE 600 31 332. That is, on the basis of the specification of the invention for the manufacture of the corresponding adhesive tape, it is possible in principle to unite the various and contradictory requirements of sufficient abrasion protection on the one hand with adequate noise reduction on the other hand, particularly with a design that is at once simple and cost-effective.

What is more, the adhesive tape according to the invention can be designed to be manually tearable and have a low overall grammage, which is typically less than 400 g/m² and preferably even less than 350 g/m² and less for the entire adhesive tape. This is explained by the fact that the substrate generally has a grammage or weight per unit area of from 100 g/m² to 200 g/m². The adhesive coating with the embedded and largely structurally stable hollow bodies preferably has an application weight or a coat weight on the substrate of from 20 g/m² to 150 g/m², which explains the total weight explained above. This low total weight is favorable for handling.

It is also of particular importance in the context of the invention that the largely structurally stable hollow bodies that are embedded in the adhesive have a grammage relative to the adhesive composition of up to 10% by mass as a maximum and, particularly, up to about 5% by mass as a maximum. This provision ensures that the individual hollow bodies, which are evenly distributed within the adhesive composition, are sufficiently spaced apart from one another. In conjunction with their closed-cell nature, the desired and improved noise reduction is simultaneously observed as compared to an adhesive tape of the same construction without hollow bodies embedded in the adhesive. At the same time, the limitation to 10% by mass as a maximum ensures that the adhesive with the added hollow bodies can be processed as described and in a conventional manner.

In fact, the upper limit of 10% by mass of hollow bodies on the one hand ensures that the individual hollow bodies are not arranged “too close” to one another in the matrix of the adhesive or the adhesive composition. Only in this way can they provide for the desired noise reduction. Moreover, too little spacing, and hence greater grammage, would weaken the layer of adhesive, so that it could rupture.

With the desired effect for noise reduction, the invention proceeds from the insight that, in the event of an incident acoustic wave, the individual closed-cell hollow bodies provide for a desired inhomogeneity of the adhesive mass in the direction of propagation of the acoustic wave and ensure that the wave front cannot propagate homogeneously through the coating made of the adhesive. Instead, on its way through the coating, the acoustic wave strikes the hollow spheres overall, which do not pass on the acoustic wave, attenuating it as desired. At the same time, the limitation to 10% by mass as a maximum ensures that the coating of the adhesive is still mechanically resilient and does not rupture, and that it has the necessary flexibility when it comes to guiding the adhesive tape around the cable to be sheathed in the manner of a wrapping tape. Finally, the limitation to 10% by mass as a maximum ensures that the adhesive composition with the added hollow bodies can still be applied to the substrate in the same manner as before by means of the conventional methods, for example using the nozzle method, the roller application method, in the form of a dispersion, etc. This means that any would-be modifications to the application method are expressly not required.

In order to be able in principle to observe the desired effect, more particularly the noise reduction effect in the adhesive tape according to the invention, it has also proven advantageous if the largely structurally stable hollow bodies having a grammage of at least 2% by mass are incorporated into the adhesive as a minimum. Otherwise, the desired noise reduction effect cannot or practically cannot be observed. However, as long as the interval described for the grammage of the hollow bodies is maintained in the range of about 2% by mass to 10% by mass, processing of the thus embodied adhesive composition is unproblematic, and the desired noise-damping effects are observed at the same time, which ultimately have the effect that the noise reduction is increased by at least approximately 10% compared to an adhesive tape of the same construction without hollow bodies in the adhesive. In fact, even an increase in noise reduction of 20% and more can be observed.

The hollow bodies as such are advantageously spherical in shape, although the invention allows any three-dimensional shape for the hollow bodies in principle. However, hollow bodies of a spherical nature have proven to be advantageous and especially favorable, since they can be processed with particular ease. After all, the hollow bodies behave like enlarged drops of liquid within the adhesive composition under this condition, so that no adverse effects are observed during processing and application to the substrate. This applies all the more in consideration of an advantageous embodiment of the preferably spherical hollow bodies in which they are configured so as to have a diameter in the range from 5 μm to 200 μm and particularly in the range from 5 μm to 150 μm. This is because such hollow bodies have a small size or a small diameter and are thus collectively embodied as hollow microbodies or hollow microspheres.

In other words, the hollow bodies are advantageously closed-cell hollow microspheres. In addition, these hollow microspheres preferably have a specific gravity of less than 0.8 g/cm³. In particular, even a specific gravity of 0.6 g/cm³ and less is observed. In any case, the specific gravity of the hollow bodies is markedly lower than that of the adhesive in which they are embedded.

Such hollow microspheres are generally available and are offered by the company 3M. In fact, the hollow microspheres can be hollow glass spheres, hollow polymer spheres, and combinations thereof. If hollow glass spheres are used, they are of the type that are normally made of water-insoluble, chemically stable borosilicate glass. Such hollow microspheres have been used previously as filler material in paints or varnishes. Due to their characteristics, they are also suitable for inclusion in hot melts or adhesive dispersions and have a largely neutral behavior therein.

The hollow microspheres can be fully or partially evacuated in order to improve the noise reduction behavior of the thus embodied adhesive. The invention proceeds here from the additional discovery that, due to the vacuum present in their interior, fully or partially evacuated hollow bodies or hollow microspheres practically do not pass on incident noise, or only to a slight extent, which explains the increased noise-reduction behavior.

1. An adhesive tape, particularly for sheathing cables in automobiles, comprising:
an elongated substrate;
an adhesive-based coating on one or both faces of the substrate; and
structurally stable hollow bodies with a grammage relative to the adhesive of the coating of up to about 10% by mass embedded in the adhesive.

2. The adhesive tape according to claim 1, wherein the hollow bodies are spherical with a diameter in the range from 5 μm to 200 μm.

3. The adhesive tape according to claim 1, wherein the hollow bodies are added to the adhesive composition and applied to the substrate together with the adhesive composition.

4. The adhesive tape according to claim 3, wherein the hollow bodies undergo during processing a change in volume in the range of up to about ±20% relative to their original volume.

5. The adhesive tape according to claim 1, wherein the hollow bodies are closed-cell hollow microspheres.

6. The adhesive tape according to claim 5, wherein the hollow microspheres have a specific gravity of less than 0.8 g/cm³.

7. The adhesive tape according to claim 5, wherein the hollow microspheres are hollow glass spheres, hollow polymer spheres, or combinations thereof.

8. The adhesive tape according to claim 5, wherein the hollow microspheres are evacuated.

9. The adhesive tape according to claim 1, wherein the coating with the adhesive has an application weight on the substrate of from 20 g/m² to 150 g/m².

10. The adhesive tape according to claim 1, wherein noise reduction is increased by at least about 10% compared to an adhesive tape of the same construction without hollow bodies in the adhesive.

11. The adhesive tape according to claim 10, wherein the noise reduction class is increased from noise reduction class C before hand to noise reduction class D according to LV 312 through the inclusion of the hollow bodies in the adhesive.

12. The adhesive tape according to any one of claims 1 to 11, claim 1, wherein the substrate has a thickness of less than 1 mm.

13. The adhesive tape according to claim 1, wherein the tape is manually tearable with a transverse tearing force of at most 10 N.

14. The adhesive tape according to claim 1, wherein the substrate is a film, a woven fabric, a nonwoven, or a knitted fabric individually or a combination thereof.

15. The adhesive tape according to claim 1, wherein the adhesive is made of rubber or acrylate, for example, and applied to the substrate as a hot-melt, dispersion, or combination thereof.

16. A method comprising the steps of:
mixing stable hollow bodies with an adhesive; and
applying the mixture of the adhesive and bodies to a face of a substrate strip at a grammage of the bodies to the adhesive of up to about 10% by mass to form an adhesive tape.

17. The method defined in claim 16, wherein the hollow bodies are glass microspheres.

18. The method defined in claim 16, further comprising the step of:
wrapping the adhesive tape around a cable.
